(19) United States
(12) Patent Application Publication
(10) Pub. No.: US 2018/0189950 A1
(43) Pub. Date: Jul. 5, 2018

(54) GENERATING STRUCTURED OUTPUT PREDICTIONS USING NEURAL NETWORKS

(71) Applicant: Google Inc., Mountain View, CA (US)

(72) Inventors: Mohammad Norouzi, Sunnyvale, CA (US); Anelia Angelova, Sunnyvale, CA (US); Michael Gygli, Zurich (CH)

(21) Appl. No.: 15/859,943

(22) Filed: Jan. 2, 2018

Related U.S. Application Data
(60) Provisional application No. 62/440,969, filed on Dec. 30, 2016.

(51) Int. Cl. G06T 7/10; G06N 5/04; G06F 15/18

(52) U.S. Cl. CPC G06T 7/10; G06N 5/046; G06T 2207/20084; G06T 2207/20081; G06F 15/18

(57) ABSTRACT

A computer-implemented method includes receiving an input data item including a plurality of data elements, and generating a predicted structured output for the input data item. Generating the predicted structured output includes iteratively performing the following operations: receiving a current structured output that assigns, to each of the data elements, a respective current value for each of the one or more categories; processing the input data item and the current output using a value neural network, in which the value neural network has been trained to process the input data item and the current output to generate a value score that is an estimate of how accurately the current output predicts the likelihoods that the elements belong to the one or more categories; and updating the current structured output by adjusting the current values in the current output to increase the value score generated by the value neural network.

### CROSS-REFERENCE TO RELATED APPLICATION

This application claims priority to U.S. Provisional Application Ser. No. 62/440,969, filed on Dec. 30, 2016. The disclosure of the prior application is considered part of and is incorporated by reference in the disclosure of this application.

### BACKGROUND

This specification relates to processing images, e.g., video frames, using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes systems and methods for generating a predicted structured output for an input data item.

In general, one innovative aspect of the subject matter described in this specification can be embodied in a computer-implemented method that includes receiving an input data item including a plurality of data elements, and generating a predicted structured output for the input data item. The predicted structured output assigns, to each of the data elements, a respective value for each of one or more categories. The value for a given element for a given category represents a likelihood that the given element in the input data item belongs to the given category. Generating the predicted structured output includes iteratively performing the following operations: receiving a current structured output that assigns, to each of the data elements, a respective current value for each of the one or more categories; processing the input data item and the current output using a value neural network, in which the value neural network has been trained to process the input data item and the current output to generate a value score that is an estimate of how accurately the current output predicts the likelihoods that the elements belong to the one or more categories; and updating the current structured output by adjusting the current values in the current output to increase the value score generated by the value neural network.

The foregoing and other embodiments can each optionally include one or more of the following features, alone or in combination. The value neural network may be a convolutional neural network. The value neural network may include one or more convolutional neural network layers followed by one or more fully-connected neural network layers. Updating the current structured output by adjusting the current values in the current structured output to increase the value score generated by the value neural network includes: determining a respective gradient value for each of the current values in the current structured output by determining a gradient of the value score with respect to the current values while holding values of parameters of the value neural network fixed; and adjusting each current value using the respective gradient value for the current value. Adjusting each current value using the respective gradient value for the current value may include: applying a learning rate constant to the respective gradient value to generate a modified gradient value; adding the modified gradient value to the current value to generate an initial adjusted value; and applying a projection operator to the adjusted value to project the adjusted value to a final adjusted value that is in a valid range of values. Iteratively performing the following operations may include iteratively performing the operations until the value score for the current output exceeds a threshold score. Iteratively performing the following operations may include iteratively performing the operations for a predetermined number of iterations. The value score is an estimate of an intersection-over-union (IOU) metric between the current structured output and the input data item. For an initial iteration of the operations, the current structured output may be a predetermined initial structured output that assigns, to each of the data elements, a respective predetermined value for each of the one or more categories. For an initial iteration of the operations, the current structured output may be a random initial structured output that assigns, to each of the data elements, a respective random value for each of the one or more categories.

Another innovative aspect of the subject matter described in this specification can be embodied in a computer-implemented method including receiving an input image comprising a plurality of image pixels; and generating a segmentation mask over the input image. The segmentation mask assigns, to each of the image pixels, a respective segmentation value for each of one or more categories. The segmentation value for a given pixel for a given category represents a likelihood that a scene depicted at the given pixel in the input image belongs to the given category. Generating the segmentation mask includes iteratively performing the following operations: receiving a current segmentation mask that assigns, to each of the image pixels, a respective current segmentation value for each of the one or more categories; processing the input image and the current segmentation mask using a value neural network, the value neural network has been trained to process the input image and the current segmentation mask to generate a value score that is an estimate of how accurately the current segmentation mask segments the pixels in the input image; and updating the current segmentation mask by adjusting the current segmentation values in the current segmentation mask to increase the value score generated by the value neural network.

The foregoing and other embodiments can each optionally include one or more of the following features, alone or in combination. The value neural network can be a convolutional neural network. The value neural network can include one or more convolutional neural network layers followed by one or more fully-connected neural network layers. Updating the current segmentation mask by adjusting the current segmentation values in the current segmentation mask to increase the value score generated by the value neural network may include: determining a respective gradient value for each of the current segmentation values in the current segmentation mask by determining a gradient of the value score with respect to the current segmentation values while holding values of parameters of the value neural network fixed; and adjusting each current segmentation value using the respective gradient value for the current segmentation value. Adjusting each current segmentation value using the respective gradient value for the current segmentation value includes: applying a learning rate constant to the respective gradient value to generate a modified gradient value; adding the modified gradient value to the current segmentation value to generate an initial adjusted segmentation value; and applying a projection operator to the adjusted segmentation value to project the adjusted segmentation value to a final adjusted segmentation value that is in a valid range of segmentation values. Iteratively performing the following operations may include iteratively performing the operations until the value score for the current segmentation mask exceeds a threshold score. Iteratively performing the following operations may include iteratively performing the operations for a predetermined number of iterations. The value score is an estimate of an intersection-over-union (IOU) metric between the current segmentation mask and the input image. For an initial iteration of the operations, the current segmentation mask can be a predetermined initial segmentation mask that assigns, to each of the image pixels, a respective predetermined segmentation value for each of the one or more categories. For an initial iteration of the operations, the current segmentation mask can be a random initial segmentation mask that assigns, to each of the image pixels, a respective random segmentation value for each of the one or more categories.

The subject matter described in this specification can be implemented in particular embodiments so as to realize one or more of the following advantages. Because structured outputs live in a high-dimensional combinatorial space, determining structured outputs is computationally challenging. Some existing models that take into consideration the computational challenge are not capable of learning complex correlations among random variables, making them not suitable for tasks requiring complicated high level reasoning to resolve ambiguity, e.g., image segmentation masking or multi-label classification tasks. The subject matter described in this specification is directed to machine learning systems that use a trained machine learning model, i.e., a trained value neural network, to efficiently predict a structured output for a given input. The value neural network is not only expressive, but also computationally tractable for both learning and inference of complicated structured output prediction tasks. In particular, the value neural network has been trained to generate value scores that estimate the quality of different output hypotheses with respect to a given input. Thus, systems that use the trained value neural network can indirectly infer the structured output for an input by finding the output that maximizes the value score, instead of directly inferring an optimal structured output, which is a computationally hard problem due to its combinatorial nature. Accordingly, systems that use the trained value neural network and the gradient descent optimizer can use less of their storage capacity, reducing system complexity, and shortening inference time while achieving the same or better results (e.g., more accurate structured output predictions) compared to existing techniques.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example machine learning system that trains a value neural network to generate a value score for a structured output prediction task.

FIG. 2 is a block diagram of an example machine learning system that uses a trained value neural network to perform a structured output prediction task.

FIG. 3 is a flow diagram of an example process 300 for iteratively updating the current structured output by adjusting the current values in the current structured output to increase the value score.

Like reference numbers and designations in the various drawings indicate like elements.

### DETAILED DESCRIPTION

This specification describes how a machine learning model can be trained and used to perform a structured output prediction task. Generally, given inputs x, a structured output prediction task involves predicting outputs y that are structured objects rather than scalar discrete values or real values. For example, structured outputs can be multivariate discrete value vectors (or other ordered collections of numeric values) in which each element in the vectors is assigned a discrete value. For instance, structured outputs can be a multivariate discrete binary vectors in which each element in the vectors is either 0 or 1.

A structured output prediction task may be, for example, an image segmentation masking task. In particular, given an input image including multiple pixels, an image segmentation masking task involves generating a segmentation mask for the input image. The segmentation mask is a structured output that assigns, to each of the image pixels in the input image, a respective value for each of one or more categories. As another example, a multi-label classification task such as predicting tags from text inputs is a structured output prediction task. For instance, given an input text including a sequence of words, a multi-label classification task involves generating a structured output that assigns, to each word in the input sentence, a respective predicted tag for each of one or more categories (e.g., word semantics category, sentiment category, etc.).

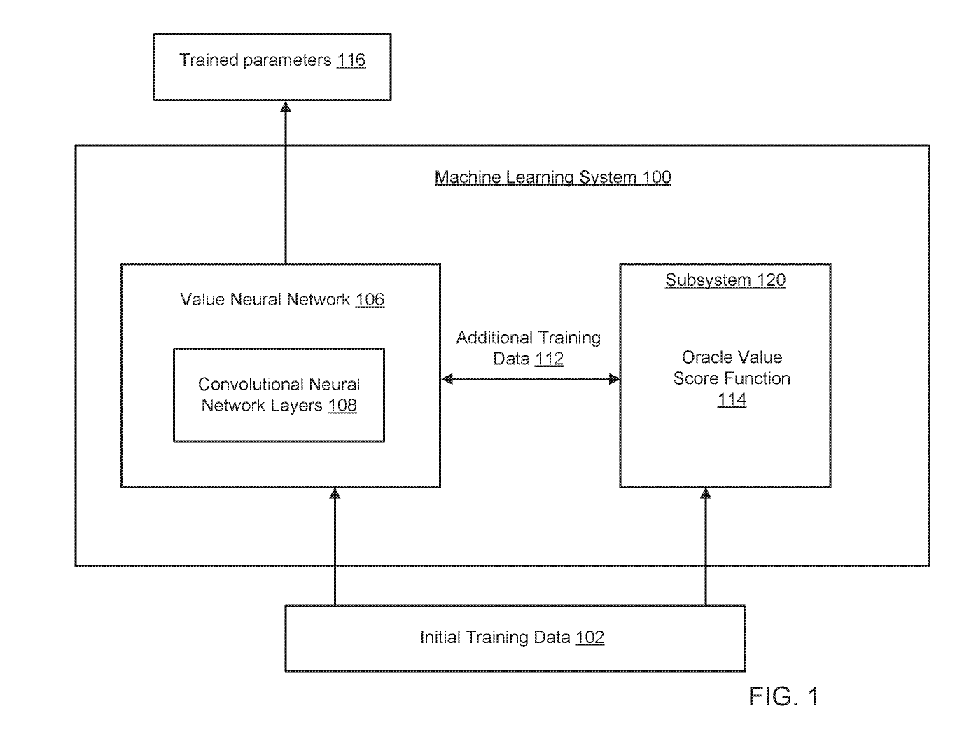

FIG. 1 is a block diagram of an example machine learning system 100 that trains a value neural network to generate a value score for a structured output prediction task. The machine learning system 100 is an example of a system implemented as computer programs on one or more computers in one or more locations, in which the systems, components, and techniques described below can be implemented.

The machine learning system 100 is generally configured to train a value neural network 106 having multiple parameters to predict the quality of different structured output hypotheses for a given input. After being trained, the value neural network 106 can be used by a system to perform a structured output prediction task, e.g., a task that involves generating a predicted structured output for a given input based on values of the parameters of the trained neural network 106.

In particular, a structured output prediction task may include receiving an input data item x ∈ X (e.g., X≡ [symbol] ^{M}) and processing the input data item to generate a predicted structured output) y ∈ Y (e.g., Y≡{0,1}^{N}), for the input data item x. The predicted structured output y can be a multivariate discrete value vector in which each element in the vectors is assigned a discrete value (e.g., 0 or 1).

For example, an image segmentation masking task includes receiving as input an input image x having multiple image pixels, and generating as output a segmentation mask ŷ over the input image x. The segmentation mask ŷ assigns, to each of the image pixels in the input image x, a respective segmentation value for each of one or more categories. The segmentation value for a given pixel for a given category represents a likelihood that a scene depicted at the given pixel in the input image belongs to the given category. For example, the segmentation value for a given pixel for a given category can be a binary value, i.e., 1 or 0, that indicates whether or not the scene depicted at the given pixel in the input image belongs to the given category.

As another example, a multi-label classification task such as predicting tags from text inputs includes receiving an input sentence x including a sequence of words, and generating a structured output ŷ that assigns, to each word in the input sentence x, a respective tag for each of one or more categories (e.g., word semantics). The respective tag for a given word for a given category represents a likelihood that the word belongs to the given category. For example, the respective tag can be a binary value, i.e., 1 or 0, which represents whether or not the word belongs to the given category.

The value neural network 106 may include one or more neural network layers. For example, in some cases, the value neural network 116 may include one or more convolutional neural network layers (e.g., convolutional neural network layers 108). In some cases, the value neural network may include one or more convolutional neural network layers followed by one or more fully connected neural network layers. In some other cases, the value neural network 116 may include other types of neural network layer such as a recurrent neural network layer, fully-connected layer, or attention-based neural network layer, or a combination of different types of neural network layers.

The operations performed by the value neural network 106 can be represented as a value function v(x,y;θ); where θ represents network parameters of the value neural network 106. The value network determines a value score that is an estimate of the quality (i.e., accuracy) of an output y and its compatibility with the input x. For example, the value score can be a real number between 0 and 1. The goal of the structured output prediction task is to find an output ŷ that yields the highest value score v(x,y;θ):

ŷ=argmax_{y}v(x,y;θ), (1)

and use this output y̅ as a predicted structured output for the input x.

During training, the value neural network 106 is configured to receive initial training data 102. The initial training data 102 includes multiple examples and, for each training example, a corresponding ground truth output. The ground truth output for a given training example is an output that should be the predicted structured output for the training example. For example, the initial training data 102 can include a set of N training example-ground truth output pairs

[symbol]

≡{(x⁽ⁱ⁾,y^{*(i)})}ᵢ₌₁^{N},

where x is a training example, and y* is a ground truth output for the training example.

The machine learning system 100 may include a subsystem 120 that is configured to generate additional training data 112. In particular, for each training example-ground truth output pair (x,y*), the subsystem 120 is configured to generate (i) one or more auxiliary outputs y and (ii) an oracle value score v*(y,y*) that quantifies the quality of each of the auxiliary outputs y.

For example, in the above image segmentation masking example, the oracle value score can be an estimate of how accurately the auxiliary output y segments the pixels in the input image x. Similarly, in the above multi-label classification example, the oracle value score can be an estimate of how accurately the auxiliary output y classifies the words in the input sentences x.

In some implementations, for image segmentation masking tasks, the oracle value score can be computed based on an oracle value score function that uses an intersection over union (IOU) metric as follows:

$${υ}_{IOU}^{*} ( y , {y}^{*} ) = \frac{y ⋂ {y}^{*}}{y ⋃ {y}^{*}} , \qquad ( 2 )$$

In some implementations, for multi-label classification tasks, the oracle value score can be computed based on an oracle value score function that uses an F1 metric as follows:

$${υ}_{{F}_{1}}^{*} ( y , {y}^{*} ) = \frac{2 ( y ⋂ {y}^{*} )}{( y ⋃ {y}^{*} ) + ( y ⋃ {y}^{*} )} . \qquad ( 3 )$$

Both of the oracle value score functions in Eq. (2) and Eq. (3) can be defined on a pair of auxiliary output and ground truth output (y,y*)∈{0,1}^{M}×{0,1}^{M}, where M is the dimension of the each output. y∩y* denotes the number of dimension i where both y and yᵢ* are active (i.e., equal to 1) and y∪y* denotes the number of dimension i where at least one of y and yᵢ* is active.

For each training example x, the subsystem 120 can generate an auxiliary output y by several methods. For example, in some implementations. the subsystem 120 can use a ground truth output y* as the auxiliary output y. In some other implementations, the subsystem 120 can generate y using a gradient based inference algorithm. In some other implementations, the subsystem 120 can randomly sample the auxiliary output y from a set of possible outputs.

For each training example x, the value neural network 106 receives from the subsystem 120 an auxiliary output y and an oracle value score v*(y,y*) that is an estimate of the quality of the auxiliary output y. The machine learning system 100 then trains the value neural network 106 on an additional training data tuple (x,y,v*)∈ [symbol] .

Given the additional training data set [symbol] , the system 100 trains the value neural network 106 to optimize the parameters θ of the value neural network 106 so that the value function v(x,y;θ) mimics the behavior the oracle value function v*(y,y*) as much as possible:

v(x,y;θ)∞v*(y,y*)

In some implementations, the system 100 can train the value neural network 106 to obtain trained parameters 116 that minimize the following objective function:

L_{CE}(θ)=Σ_{(x,y,v*)∈D}−v* log v(x,y;θ)−(1−v*)log(1−v(x,y;θ)) (4)

The value neural network 106 can be trained using standard training techniques such as conventional gradient descent-based methods, e.g., stochastic gradient descent, the Adam method, and so on.

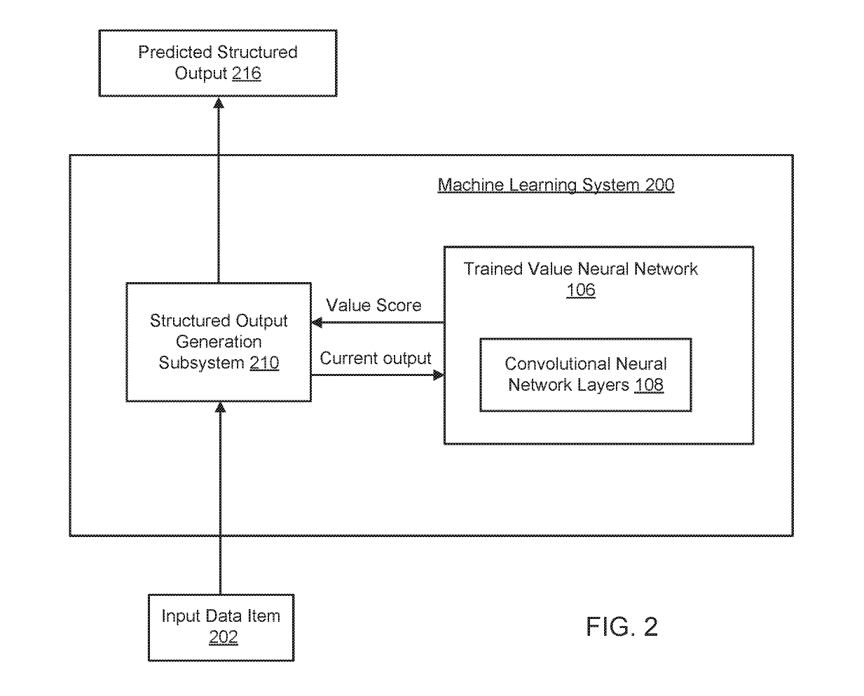

FIG. 2 is a block diagram of an example machine learning system 200 that uses a trained value neural network to perform a structured output prediction task. The machine learning system 200 is an example of a system implemented as computer programs on one or more computers in one or more locations, in which the systems, components, and techniques described below can be implemented. In some implementation, the machine learning system 200 is the machine learning system 100. In some other implementation, the machine learning system 200 is a separate, different system from the system 100.

The machine learning system 200 includes a structured output generation subsystem 210 and a trained value neural network, e.g., the value neural network 106 of FIG. 1 that has already been trained to generate a value score for the structured output prediction task.

The structured output generation subsystem 210 is configured to receive an input data item x ∈ X (e.g., X≡ [symbol] ^{M}) and to process the input data item to generate a predicted structured output y ∈ Y (e.g., Y≡{0,1}^{N}), for the input data item x based on the values of the parameters of the trained value neural network 106. The predicted structured output y can be a multivariate discrete vector in which each element in the vectors is assigned a discrete value (e.g., 0 or 1).

For example, in some implementations, to perform an image segmentation masking task, the subsystem 210 may receive as input an input image x having multiple image pixels. The subsystem 210 is then configured to generate as output a segmentation mask ŷ over the input image x. The segmentation mask ŷ assigns, to each of the image pixels in the input image x, a respective segmentation value for each of one or more categories. The segmentation value for a given pixel for a given category represents a likelihood that a scene depicted at the given pixel in the input image belongs to the given category. For example, the segmentation value for a given pixel for a given category can be a binary value, i.e., 1 or 0, that indicates whether or not the scene depicted at the given pixel in the input image belongs to the given category.

In some other implementations, to perform a multi-label classification task such as predicting tags from text inputs, the subsystem 210 may receive an input sentence x including a sequence of words. The subsystem 210 is configured to generate a structured output ŷ that assigns, to each word in the input sentence x, a respective tag for each of one or more categories (e.g., word semantics). The respective tag for a given word for a given category represents a likelihood that the word belongs to the given category. For example, the respective tag can be a binary value, i.e., 1 or 0, which represents whether or not the word belongs to the given category.

To generate the predicted structured output \vec{y} for the input data item x, the system 200 is configured to iteratively perform a set of operations as described below.

During each iteration, the system 200 first receives, at the structured output generation subsystem 210, a current structured output y^{(t)} that assigns, to each elements of the input data item x, a respective value for each of the one or more categories. A respective value for each of the one or more categories can be a binary value (i.e., 1 or 0) indicating whether or not the element belongs to the category.

The system 200 is then configured to process, using the trained value neural network 106, the input data item and the current structured output y^{(t)} to generate a value score v(x,y^{(t)}) that is an estimate of the quality of the current structured output y^{(t)}, i.e. how accurately the current structured output y^{(t)} predicts, for each element in the input data item, a category that the element belongs to.

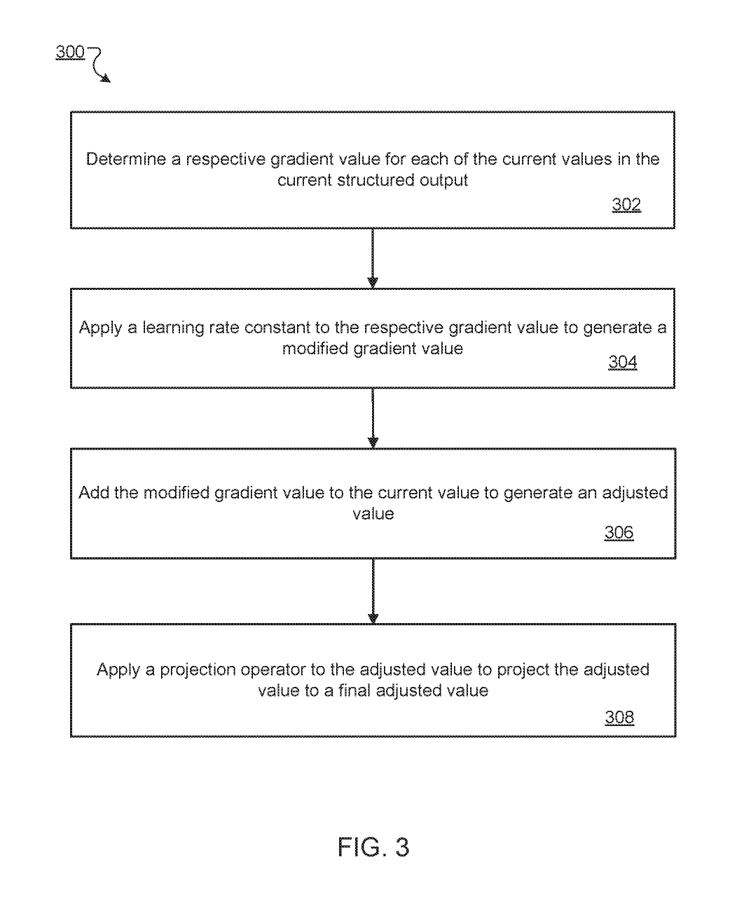

The system 200 then updates the current structured output y^{(t)} by adjusting the current values in the current structured output y^{(t)} to increase the value score v(x,y^{(t)}). The process for updating the current structured output y^{(t)} is described in more detail below with reference to FIG. 3.

In some implementations, for the initial iteration of the operations, the current structured output y^{(t)} is a predetermined initial structured output that assigns, to each element of the input data item, a respective predetermined value for each of the one or more categories. For example, the initial structured output y⁽⁰⁾ can be initialized as y⁽⁰⁾=[0]^{M}, i.e., all values in the initial structured output y⁽⁰⁾ are set as zero. M is the number of dimensions of the current structured output y^{(t)}.

In some implementations, for the initial iteration, the current structured output y^{(t)} is a random initial structured output that assigns, to each element of the input data item, a respective random value for each of the one or more categories.

The system 200 can iteratively perform the above operations until a criterion is satisfied. For example, the system 200 can iteratively perform the above operations until the value score for the current structured output y^{(t)} exceeds a threshold score. As another example, the system 200 can iteratively perform the above operations for a predetermined number of iterations. The structured output y^{(T)} obtained after performing the final iteration (e.g., the T^{th} iteration) is the predicted structured output ŷ for the input data item x.

Once the predicted structured output ŷ has been generated, the machine learning system 200 can use the predicted structured output for a variety of purposes.

For instance, when the system 200 performs an image segmentation mask task to generate a segmentation mask for an input image, once the segmentation mask has been generated, the system 200 can use the segmentation mask for many purposes. For example, the system 200 can store the segmentation mask in association with the image for later use. As another example, the system 200 can modify the image based on the segmentation mask, i.e., to distinguish between pixels belonging to different categories, and present the modified image to a user. As another example, the system 200 can generate one or more overlays over the image based on the segmentation mask, e.g., so that each overlay emphasizes pixels belonging to a different category, and provide the overlays for presentation to a user in an image editing application. As yet another example, the system 200 can provide the segmentation mask and the image as input to an image processing system that performs an image processing task on the image, e.g., image classification, object recognition, object identification, or object detection.

FIG. 3 is a flow diagram of an example process 300 for iteratively updating the current structured output by adjusting the current values in the current structured output to increase the value score. For convenience, the process 300 will be described as being performed by a system of one or more computers located in one or more locations. For example, a machine learning system, e.g., the machine learning system 200 of FIG. 2, appropriately programmed in accordance with this specification, can perform the process 300.

As shown in the process 300 of FIG. 3, the system first determines a respective gradient value for each of the current values in the current structured output by determining a gradient of the value score with respect to the current values while holding values of parameters of the trained value neural network fixed (step 302).

In particular, assuming that the current structured output is y^{(t)}, the system determines a gradient of the value score v(x,y^{(t)}) with respect to the current values in y^{(t)} as follows:

$$\frac{d}{dy} υ ( x , {y}^{( t )} ; θ ) ,$$

where θ denotes values of parameters of the trained value neural network (e.g., the trained value neural network 106 of FIG. 2) that are held fixed. The system determines the output by backpropagating gradients with respect to the current values in the current output y^{(t)} through the trained value neural network.

The system then adjusts each of the current values in the current structured output using the respective gradient value for the current value by performing the following steps.

The system applies a learning rate constant to the respective gradient value to generate a modified gradient value (step 304). In particular, the modified gradient value can be determined as

$$η \frac{d}{dy} υ ( x , {y}^{( t )} ; θ ) ,$$

where η is a learning rate constant. In some implementations, the learning rate can be constant. In some other implementations, the learning rate can change for different iterations (for example, the learning rate can decrease by a fixed rate schedule as iterations proceed).

The system adds the modified gradient value to the current value to generate an adjusted value (step 306).

In particular, the adjusted value has the following form:

$${y}^{( t )} + η \frac{d}{dy} υ ( x , {y}^{( t )} ; θ )$$

The system applies a projection operator to the adjusted value to project the adjusted value to a final adjusted value that is in a valid range of values (step 308). In particular, the projection produces final adjusted values in an updated structured output y^{(t+1)} having the following form:

$${y}^{( t + 1 )} = ( {y}^{( t )} + η \frac{d}{dy} υ ( x , {y}^{( t )} ; θ ) ) , \qquad ( 5 )$$

where P_{Y} denotes a predetermined projection operator that projects the adjusted structured output that includes adjusted values back to a feasible set of structured outputs Y so that y^{(t+1)} remains in Y. For example, if the feasible set of structured outputs is y ∈ [0,1]^{M}, after step 306, an adjusted value in the adjusted structured output may go a little outside the [0,1] range, e.g., may get a value −0.03. In that case the projection operator P_{Y} will be applied to bring back the value to the [0,1] range, i.e., it will set the value −0.03 to 0. Thus, it is guaranteed that the next iteration works with values in the [0,1] range.

The system can iteratively perform the steps 302-308 until a criterion is satisfied, for example, until the value score for the current structured output exceeds a threshold value or until a predetermined number of iterations have been performed. The current structured output obtained after performing the final iteration is the predicted structured output ŷ for the input data item x.

The subject matter described in this specification can be implemented in particular embodiments so as to realize one or more of the following advantages. Because structured outputs live in a high-dimensional combinatorial space, determining structured outputs is computationally challenging. Some existing models that take into consideration the computational challenge are not capable of learning complex correlations among random variables, making them not suitable for tasks requiring complicated high level reasoning to resolve ambiguity, e.g., image segmentation masking or multi-label classification tasks. The subject matter described in this specification is directed to machine learning systems that use a trained machine learning model, i.e., a trained value neural network, to efficiently predict a structured output for a given input. The value neural network is not only expressive, but also computationally tractable for both learning and inference of complicated structured output prediction tasks. In particular, the value neural network has been trained to generate value scores that estimate the quality of different output hypotheses with respect to a given input. Thus, systems that use the trained value neural network can indirectly infer the structured output for an input by finding the output that maximizes the value score, instead of directly inferring an optimal structured output, which is a computationally hard problem due to its combinatorial nature. Accordingly, systems that implement the trained value neural network can use less of their storage capacity, reducing system complexity, and shortening inference time while achieving the same or better results compared to existing techniques.

As described throughout the specification, given an input data item x, a system using a trained value neural network aims to find a predicted structured output ŷ that maximizes the value score, i.e., ŷ=argmax_{y} v(x,y;θ). Since v(x,y;θ) represents a complex non-linear function of (x,y) induced by the value neural network, determining ŷ is a technical challenge. To overcome the technical difficulty, the techniques described in this specification use a simple gradient descent optimizer for inference. To facilitate that, before performing step 302 of the process 300 in FIG. 3, the system can relax the current values in the current structured output to live in a real-value space.

For example, in some implementations, instead of using y ∈ {0,1}^{M}, the system can use y ∈ [0,1]^{M}. In these implementations, after performing the step 308 of the process 300 in FIG. 3, the system can use the projection operator to project dimensions having values smaller than zero back to zero, and dimensions having values larger than one to one. After the final gradient iteration T, the system can simply round y^{(T)} to become discrete.

The value neural network incorporating the above-described techniques is not only expressive, but also computationally tractable for both learning and inference of structured output prediction tasks. Systems that implement the trained value neural network can use less of their storage capacity, reducing system complexity, and shorting training and inference time while achieving the same or better results compared to existing techniques.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving an input data item comprising a plurality of data elements; and
generating a predicted structured output for the input data item,
wherein the predicted structured output assigns, to each of the data elements, a respective value for each of one or more categories,
wherein the value for a given element for a given category represents a likelihood that the given element in the input data item belongs to the given category, and
wherein generating the predicted structured output comprises iteratively performing the following operations:
receiving a current structured output that assigns, to each of the data elements, a respective current value for each of the one or more categories;
processing the input data item and the current output using a value neural network,
wherein the value neural network has been trained to process the input data item and the current output to generate a value score that is an estimate of how accurately the current structured output predicts the likelihoods that the elements belong to the one or more categories; and
updating the current structured output by adjusting the current values in the current output to increase the value score generated by the value neural network.

2. The method of claim 1, wherein the value neural network is a convolutional neural network.

3. The method of claim 2, wherein the value neural network comprises one or more convolutional neural network layers followed by one or more fully-connected neural network layers.

4. The method of claim 1, wherein updating the current structured output by adjusting the current values in the current structured output to increase the value score generated by the value neural network comprises:
determining a respective gradient value for each of the current values in the current structured output by determining a gradient of the value score with respect to the current values while holding values of parameters of the value neural network fixed; and
adjusting each current value using the respective gradient value for the current value.

5. The method of claim 4, wherein adjusting each current value using the respective gradient value for the current value comprises:
applying a learning rate constant to the respective gradient value to generate a modified gradient value;
adding the modified gradient value to the current value to generate an adjusted value; and
applying a projection operator to the adjusted value to project the adjusted value to a final adjusted value that is in a valid range of values.

6. The method of claim 1, wherein iteratively performing the following operations comprises iteratively performing the operations until the value score for the current output exceeds a threshold score.

7. The method of claim 1, wherein iteratively performing the following operations comprises iteratively performing the operations for a predetermined number of iterations.

8. The method of claim 1, wherein, for an initial iteration of the operations, the current structured output is a predetermined initial structured output that assigns, to each of the data elements, a respective predetermined value for each of the one or more categories.

9. The method of claim 1, wherein, for an initial iteration of the operations, the current structured output is a random initial structured output that assigns, to each of the data elements, a respective random value for each of the one or more categories.

10. A system comprising one or more computers and one or more storage devices storing instructions that when executed by the one or more computers cause the one or more computers to perform operations comprising:
receiving an input data item comprising a plurality of data elements; and
generating a predicted structured output for the input data item,
wherein the predicted structured output assigns, to each of the data elements, a respective value for each of one or more categories,
wherein the value for a given element for a given category represents a likelihood that the given element in the input data item belongs to the given category, and
wherein generating the predicted structured output comprises iteratively performing the following operations:
receiving a current structured output that assigns, to each of the data elements, a respective current value for each of the one or more categories;
processing the input data item and the current output using a value neural network,
wherein the value neural network has been trained to process the input data item and the current output to generate a value score that is an estimate of how accurately the current output predicts the likelihoods that the elements belong to the one or more categories; and
updating the current structured output by adjusting the current values in the current output to increase the value score generated by the value neural network.

11. The system of claim 10, wherein updating the current structured output by adjusting the current values in the current structured output to increase the value score generated by the value neural network comprises:
determining a respective gradient value for each of the current values in the current structured output by determining a gradient of the value score with respect to the current values while holding values of parameters of the value neural network fixed; and
adjusting each current value using the respective gradient value for the current value.

12. The system of claim 11, wherein adjusting each current value using the respective gradient value for the current value comprises:
applying a learning rate constant to the respective gradient value to generate a modified gradient value;
adding the modified gradient value to the current value to generate an initial adjusted value; and
applying a projection operator to the adjusted value to project the adjusted value to a final adjusted value that is in a valid range of values.

13. The system of claim 10, wherein iteratively performing the following operations comprises iteratively performing the operations until the value score for the current output exceeds a threshold score.

14. The system of claim 10, wherein iteratively performing the following operations comprises iteratively performing the operations for a predetermined number of iterations.

15. One or more non-transitory computer storage media storing instructions that when executed by one or more computers cause the one or more computers to perform operations comprising:
receiving an input data item comprising a plurality of data elements; and
generating a predicted structured output for the input data item,
wherein the predicted structured output assigns, to each of the data elements, a respective value for each of one or more categories,
wherein the value for a given element for a given category represents a likelihood that the given element in the input data item belongs to the given category, and
wherein generating the predicted structured output comprises iteratively performing the following operations:
receiving a current structured output that assigns, to each of the data elements, a respective current value for each of the one or more categories;
processing the input data item and the current output using a value neural network,
wherein the value neural network has been trained to process the input data item and the current output to generate a value score that is an estimate of how accurately the current output predicts the likelihoods that the elements belong to the one or more categories; and
updating the current structured output by adjusting the current values in the current output to increase the value score generated by the value neural network.

16. The non-transitory computer storage media of claim 15, wherein updating the current structured output by adjusting the current values in the current structured output to increase the value score generated by the value neural network comprises:
determining a respective gradient value for each of the current values in the current structured output by determining a gradient of the value score with respect to the current values while holding values of parameters of the value neural network fixed; and
adjusting each current value using the respective gradient value for the current value.

17. The non-transitory computer storage media of claim 16, wherein adjusting each current value using the respective gradient value for the current value comprises:
applying a learning rate constant to the respective gradient value to generate a modified gradient value;
adding the modified gradient value to the current value to generate an initial adjusted value; and
applying a projection operator to the adjusted value to project the adjusted value to a final adjusted value that is in a valid range of values.

18. The non-transitory computer storage media of claim 15, wherein iteratively performing the following operations comprises iteratively performing the operations until the value score for the current output exceeds a threshold score.

19. The non-transitory computer storage media of claim 15, wherein iteratively performing the following operations comprises iteratively performing the operations for a predetermined number of iterations.

20. The non-transitory computer storage media of claim 15, wherein, for an initial iteration of the operations, the current structured output is a predetermined initial structured output that assigns, to each of the data elements, a respective predetermined value for each of the one or more categories.
